(19) United States
(12) Patent Application Publication
(10) Pub. No.: US 2016/0144604 A1
(43) Pub. Date: May 26, 2016

(54) Coextruded Multilayer Film with Barrier Properties

(71) Applicant: DOW GLOBAL TECHNOLOGIES LLC, Middland, MI (US)

(72) Inventors: Steven R. Jenkins, Traverse City, MI (US); Patrick Chang Dong Lee, Midland, MI (US); Joseph Dooley, Midland, MI (US); Donald E. Kirkpatrick, Lake Jackson, TX (US); Bernard E. Obi, Missouri City, TX (US)

(21) Appl. No.: 14/900,442

(22) PCT Filed: Jun. 25, 2014
(86) PCT No.: PCT/US2014/044068

§ 371 Date: Dec. 21, 2015

Related U.S. Application Data
(60) Provisional application No. 61/840,593, filed on Jun. 28, 2013.

(51) Int. Cl. B32B 27/08; B32B 27/30; B32B 27/32

(52) U.S. Cl. CPC B32B 27/08; B32B 27/32; B32B 27/325; B32B 27/302; B32B 2250/42; B32B 2250/05; B32B 2307/724; B32B 2439/00

(57) ABSTRACT

The disclosure provides a coextruded multilayer film. The coextruded multilayer film includes a core component having from 15 to 1000 alternating layers of layer A and layer B. Layer A has a thickness from 100 nm to 500 nm and includes an ethylene-based polymer. Layer B has a thickness from 100 nm to 500 nm and includes a cyclic olefin polymer (“COP”). Layer A has an effective moisture permeability less than 0.20 g-mil/100 in²/day and an effective oxygen permeability less than 150 cc-mil/100 in²/day/atm. In an embodiment, the multilayer film includes skin layers.

### BACKGROUND

The present disclosure is directed to multilayer films with nanolayer structures that provide barrier properties.

There are many applications for plastic films or sheets where improved barrier properties would be beneficial. For example, a film with a downgauged overall thickness, utilizing less volume to achieve a given barrier, can provide improved toughness and other properties via the “freed up” volume being used by polymers providing other attributes than barrier.

Consequently, a need exists for films with improved barrier properties. A need further exists for films that enable downgauged packaging systems with improved barrier properties.

### SUMMARY

The present disclosure is directed to coextruded multilayer films with a core component that is a nanolayer structure. The nanolayer structure provides the multilayer film with improved barrier properties. By coextruding materials to form a specified nanolayer structure, films or sheets are provided having an unexpected combination of improved moisture barrier and improved gas barrier properties.

In an embodiment a coextruded multilayer film is provided. The coextruded multilayer film includes a core component having from 15 to 1000 alternating layers of layer A and layer B. Layer A has a thickness from 100 nm to 500 nm and includes an ethylene-based polymer. Layer B has a thickness from 100 nm to 500 nm and includes a cyclic olefin polymer (“COP”). Layer A has an effective moisture permeability less than 0.20 g-mil/100 in²/day (less than 3.1 g-mil/m²/24 hour (hr)) and an effective oxygen permeability less than 150 cc-mil/100 in²/day/atm (less than 2325 cc-mil/m²/atm).

In an embodiment, the multilayer film includes skin layers.

### BRIEF DESCRIPTION OF THE DRAWING

The accompanying Figures together with the following description serve to illustrate and provide a further understanding of the disclosure and its embodiments and are incorporated in and constitute a part of this specification.

FIG. 1 is a schematic diagram illustrating a method of making a multilayer film or sheet structure in accordance with an embodiment of the present disclosure.

FIG. 2 is a schematic representation of spherulitic lamellae configurations in micro-/nano-layer structures.

FIG. 3 is a graph showing effective moisture permeability vs. barrier layer thickness in accordance with an embodiment of the present disclosure.

FIG. 4 is the graph of FIG. 3 with transmission electron microscopy (TEM) images of core components in accordance with embodiments of the present disclosure.

### DEFINITIONS

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend.

The term “composition” and like terms mean a mixture of two or more materials, such as a polymer which is blended with other polymers or which contains additives, fillers, or the like. Included in compositions are pre-reaction, reaction and post-reaction mixtures the latter of which will include reaction products and by-products as well as unreacted components of the reaction mixture and decomposition products, if any, formed from the one or more components of the pre-reaction or reaction mixture.

An “ethylene-based polymer is a polymer that contains more than 50 mole percent polymerized ethylene monomer (based on the total amount of polymerizable monomers) and, optionally, may contain at least one comonomer.

As used herein, the term “film”, including when referring to a “film layer” in a thicker article, unless expressly having the thickness specified, includes any thin, flat extruded or cast thermoplastic article having a generally consistent and uniform thickness up to about 0.254 millimeters (10 mils). “Layers” in films can be very thin, as in the cases of nanolayers discussed in more detail below.

As used herein, the term “sheet”, unless expressly having the thickness specified, includes any thin, flat extruded or cast thermoplastic article having a generally consistent and uniform thickness greater than “film”, generally at least 0.254 millimeters thick and up to about 7.5 mm (295 mils) thick. In some cases sheet is considered to have a thickness of up to 6.35 mm (250 mils).

Either film or sheet, as those terms are used herein can be in the form of shapes, such as profiles, parisons, tubes, and the like, that are not necessarily “flat” in the sense of planar but utilize A and B layers according to the present disclosure and have a relatively thin cross section within the film or sheet thicknesses according to the present disclosure.

“Interpolymer” means a polymer prepared by the polymerization of at least two different monomers. This generic term includes copolymers, usually employed to refer to polymers prepared from two or more different monomers, and includes polymers prepared from more than two different monomers, e.g., terpolymers, tetrapolymers, etc.

“Melting Point” as used herein is typically measured by the DSC technique for measuring the melting peaks of polyolefins as described in U.S. Pat. No. 5,783,638. It should be noted that many blends comprising two or more polyolefins will have more than one melting peak; many individual polyolefins will comprise only one melting peak.

A “nanolayer structure,” as used herein, is a multilayer structure having two or more layers each layer with a thickness from 1 nanometer to 900 nanometers.

An “olefin-based polymer,” as used herein is a polymer that contains more than 50 mole percent polymerized olefin monomer (based on total amount of polymerizable monomers), and optionally, may contain at least one comonomer. Nonlimiting examples of olefin-based polymer include ethylene-based polymer and propylene-based polymer.

“Polymer” means a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term interpolymer as defined below. It also embraces all forms of interpolymers, e.g., random, block, etc. The terms “ethylene/α-olefin polymer” and “propylene/α-olefin polymer” are indicative of interpolymers as described below prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is obviously understood to be referring to the polymerized remnant of the specified monomer and not to the unpolymerized species. In general, polymers herein are referred to has being based on “units” that are the polymerized form of a corresponding monomer.

A “propylene-based polymer” is a polymer that contains more than 50 mole percent polymerized propylene monomer (based on the total amount of polymerizable monomers) and, optionally, may contain at least one comonomer.

The numerical figures and ranges here are approximate, and thus may include values outside of the range unless otherwise indicated. Numerical ranges (e.g., as “X to Y”, or “X or more” or “Y or less”) include all values from and including the lower and the upper values, in increments of one unit, provided that there is a separation of at least two units between any lower value and any higher value. As an example, if a compositional, physical or other property, such as, for example, temperature, is from 100 to 1,000, then all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. For ranges containing explicit values (e.g., 1 or 2, or 3 to 5, or 6, or 7) any subrange between any two explicit values is included (e.g., 1 to 2; 2 to 6; 5 to 7; 3 to 7; 5 to 6; etc.). These are only examples of what is specifically intended, and all possible combinations of numerical values between the lowest value and the highest value enumerated, are to be considered to be expressly stated in this disclosure.

### DETAILED DESCRIPTION

The present disclosure provides a multilayer film. In an embodiment, a coextruded multilayer film is provided and includes a core component. The core component includes from 15 to 1000 alternating layers of layer A and layer B. Layer A has a thickness from 100 nm to 500 nm and includes an ethylene-based polymer. Layer B has a thickness from 100 nm to 500 nm and includes a cyclic olefin polymer (“COP”). Layer A has an effective moisture permeability less than 0.20 g-mil/100 in²/day (less than 3.1 g-mil/m²/24 hr) and an effective oxygen permeability less than 150 cc-mil/100 in²/day/atm (2325 cc-mil/m²/24 hr/atm).

1. Layer A

The core component of the present multilayer film includes from 15 or 30 to 1000 alternating layers of layer A and layer B. Layer A includes an ethylene-based polymer. The ethylene-based polymer may be an ethylene homopolymer or an ethylene/α-olefin copolymer. The ethylene-based polymer has a melt index from 0.01 g/10 minutes (g/10 min) to 35 g/10 min.

Layer A includes an ethylene-based polymer. In an embodiment, the layer A includes a high density polyethylene (HDPE). A “high density polyethylene” (or “HDPE”), as used herein, is an ethylene-based polymer having a density of at least 0.94 g/cc, or from at least 0.94 Wee to 0.98 g/cc. The HDPE has a melt index from 0.1 g/10 min to 25 g/10 min.

The HDPE can include ethylene and one or more C₃-C₂₀ α-olefin comonomers. The comonomer(s) can be linear or branched. Nonlimiting examples of suitable comonomers include propylene, 1-butene, 1-pentene, 4-methyl-1-pentene, 1-hexene, and 1-octene. The HDPE can be prepared with either Ziegler-Natta, chromium-based, constrained geometry or metallocene catalysts in slurry reactors, gas phase reactors or solution reactors. The ethylene/C₃-C₂₀ α-olefin comonomer includes at least 50 percent by weight ethylene polymerized therein, or at least 70 percent by weight, or at least 80 percent by weight, or at least 85 percent by weight, or at least 90 weight percent, or at least 95 percent by weight ethylene in polymerized form.

In an embodiment, the HDPE is an ethylene/α-olefin copolymer with a density from 0.95 g/cc to 0.97 g/cc, and a melt index from 0.1 g/10 min to 10 g/10 min.

In an embodiment, the HDPE has a density from 0.960 g/cc to 0.970 g/cc, and a melt index from 0.1 g/10 min to 10 g/10 min.

In an embodiment, the HDPE has a density from 0.95 g/cc, or 0.96 glee to 0.97 g/cc and a melt index from 0.1 g/10 min to 10 g/min.

In an embodiment, the HDPE has a density from 0.96 g/cc to 0.97 g/cc and a melt index from 0.1 g/10 min to 10 g/10 min.

Nonlimiting examples of suitable HDPE include ELITE 5960G, HDPE KT 10000 UE, HDPE KS 10100 UE and HDPE 35057E, each available from The Dow Chemical Company Midland, Mich., USA.

The HDPE may comprise two or more of the foregoing embodiments.

In an embodiment, layer A may include a blend of the HDPE and one or more additional polymers. Nonlimiting examples of suitable blend components for layer A include ethylene-based polymers, propylene-based polymers, and combinations thereof.

2. Layer B

The core component of the present multilayer film includes from 15 or 30 to 1000 alternating layers of layer A and layer B. Layer B includes a cyclic olefin polymer. A “cyclic olefin polymer (or “COP”) is an olefin-based polymer that includes a saturated hydrocarbon ring. Suitable COPs include at least 25 wt % cyclic units, which weight percentage is calculated based on the weight percentage of the olefin monomer units containing, including functionalized to contain, the cyclic moiety (“MCCM”) that is polymerized into the COP as a percentage of the total weight of monomers polymerized to form the final COP.

In an embodiment, the COP includes at least 40 wt %, or at least 50 wt % or at least 75 wt % MCCM. The cyclic moiety can be incorporated in the backbone of the polymer chain (such as from a norbornene ring-opening type of polymerization) and/or pendant from the polymer backbone (such as by polymerizing styrene (which is eventually hydrogenated to a cyclic olefin) or other vinyl-containing cyclic monomer). The COP can be a homopolymer based on a single type of cyclic unit; a copolymer comprising more than one cyclic unit type; or a copolymer comprising one or more cyclic unit type and other incorporated monomer units that are not cyclic, such as units provided by or based on ethylene monomer. Within copolymers, the cyclic units and other units can be distributed in any way including randomly, alternately, in blocks or some combination of these. The cyclic moiety in the COP need not result from polymerization of a monomer comprising the cyclic moiety per se but may result from cyclicly functionalizing a polymer or other reaction to provide the cyclic moiety units or to form the cyclic moiety from a cyclic moiety precursor. As an example, styrene (which is a cyclic moiety precursor but not a cyclic unit for purposes of this disclosure) can be polymerized to a styrene polymer (not a cyclic olefin polymer) and then later be completely or partially hydrogenated to result in a COP.

The MCCMs which can be used in polymerization processes to provide cyclic units in COP's include but are not limited to norbornene and substituted norbornenes. As mentioned above, cyclic hexane ring units can be provided by hydrogenating the styrene aromatic rings of styrene polymers. The cyclic units can be a mono- or multi-cyclic moiety that is either pendant to or incorporated in the olefin polymer backbone. Such cyclic moieties/structures include cyclobutane, cyclohexane or cyclopentane, and combinations of two or more of these. For example, cyclic olefin polymers containing cyclohexane or cyclopentane moieties are α-olefin polymers of 3-cyclohexyl-1-propene (allyl cyclohexane) and vinyl cyclohexane.

In an embodiment, the COP is a cyclic olefin block copolymers (or “CBC”) prepared by producing block copolymers of butadiene and styrene that are then hydrogenated, preferably fully hydrogenated, to a CBC. Nonlimiting examples of suitable CBC include CBC that is fully hydrogenated di-block (SB), tri-block (SBS) and penta-block (SBSBS) polymer. In such tri- and penta-block copolymer, each block of a type of unit is the same length; i.e., each S block is the same length and each B block is the same length. Total molecular weight (Mn) prior to hydrogenation is from about 25,000 to about 1,000,000 g/mol. The percent of styrene incorporated is from 10 to 99 wt %, or from 50 to 95 wt % or from 80 to 90 wt %, the balance being butadiene. For example, WO2000/056783(A1), incorporated by reference herein, discloses the preparation of such pentablock types of COPs.

Other CON are described in Yamazaki, Journal of Molecular Catalysis A: Chemical, 213 (2004) 81-87; and Shin et al., Pure Appl. Chem., Vol. 77, No. 5, (2005) 801-814. In the publication from Yamazaki (of Zeon Chemical) the polymerization of a COP is described as based on a ring opening metathesis route via norbornene. Commercially available COP products from Zeon Chemical are described as an amorphous polyolefin with a bulky ring structure in the main chain, based on dicyclopentadiene as the main monomer and saturating the double bond in norbornene ring-opening metathesis with a substituent (R) by hydrogenation. A nonlimiting example of a suitable is COP is Zeonor 1420 sold by Zeon Chemical.

Another example of COPs are the Topas brand cyclic olefin copolymers commercially available from Topas Advanced Polymers GmbH which are amorphous, transparent copolymers based on cyclic olefins (i.e., norbornene) and linear olefins (e.g., ethylene), with heat properties being increased with higher cyclic olefin content. Preferably such COPs are represented by the following formula with the x and y values selected to provide suitable thermoplastic polymers:

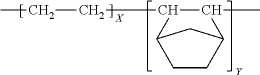

The layers comprising the COPs can be made from COPs or can comprise physical blends of two or more COPs and also physical blends of one or more COP with polymers that are not COPs provided that any COP blends or compositions comprise at least 25 wt % cyclic olefin unit content in the total blend or composition.

In an embodiment, layer B includes a cyclic block copolymer.

In an embodiment, layer B includes a cyclic block copolymer that is a pentablock hydrogenated styrene.

3. Core Component

The core component of the present multilayer film includes from 15 or 30 to 1000 alternating layers of layer A and layer B.

In an embodiment, the core component includes from 15, or 30, or 33, or 50, or 60, or 65, or 70, or 100, or 129, or 150, or 200 to 250, or 257, or 300, or 400, or 450, or 500, or 1000 alternating layers of layer A and layer B.

The thickness of layer A and layer B can be the same or different. In an embodiment, the thickness of layer A is the same, or substantially the same, as the thickness of layer B. Layer A has a thickness from 100 nm, or 150 nm, or 198 nm, or 200 nm, or 250 nm, or 261 nm, or 290 nm, or 300 nm to 350 nm, or 396 nm, or 400 nm, or 440 nm, or 450 nm, or 470 nm, or 500 nm. Layer B has a thickness from 100 nm, or 150 nm, or 198 nm, or 200 nm, or 250 nm, or 261 nm, or 290 nm, or 300 nm to 350 nm, or 396 nm, or 400 nm, or 440 nm, or 450 nm, or 470 nm, or 500 nm.

The number of A layers and B layers present in the core component can be the same or different. In an embodiment, the A:B layer ratio (number of A layers to the number of B layers) is from 1:1, or 3:1, to 9:1.

In an embodiment, the core component includes 60 to 70, or 65 alternating layers of layer A and layer B and the core component has an A:B layer ratio from 50:50, or 75:25 to 90:10. Layer A has a thickness from 100 nm to 400 nm.

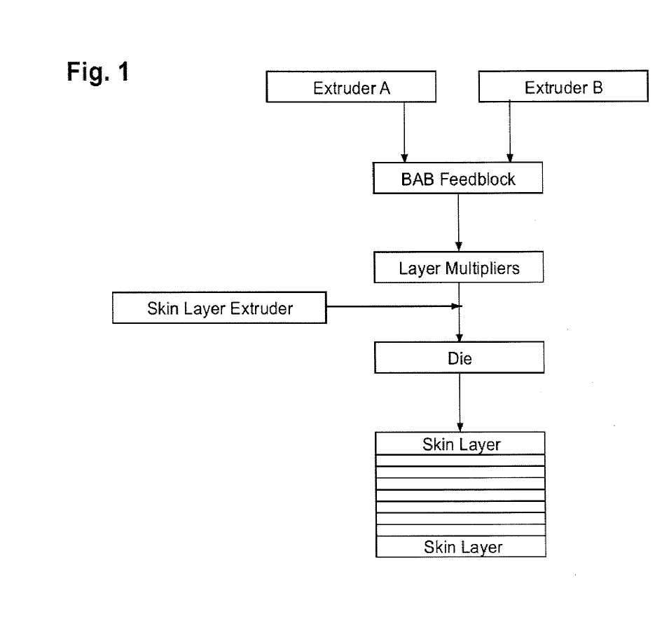

The core component may be produced with a multilayer coextrusion apparatus as generally illustrated in FIG. 1. The feedblock for a multi-component multilayer system usually combines the polymeric components into a layered structure of the different component materials. The starting layer thicknesses (their relative volume percentages) are used to provide the desired relative thicknesses of the A and B layers in the final film.

The present core component is a two component structure composed of polymeric material “A” (produces layer A) and polymeric material “B” (produces layer 13) and is initially coextruded into a starting “AB” or “ABA” layered feedstream configuration where “A” represents layer A and “B” represents layer B. Then, known layer multiplier techniques can be applied to multiply and thin the layers resulting from the feedstream. Layer multiplication is usually performed by dividing the initial feed stream into 2 or more channels and “stacking” of the channels. The general formula for calculation of the total numbers of layers in a multilayer structure using a feedblock and repeated, identical layer multipliers is: Nₜ=(Nₗ)(F)ⁿ where: Nₜ is the total number of layers in the final structure; Nₗ is the initial number of layers produced by the feedblock; F is the number of layer multiplications in a single layer multiplier, usually the “stacking” of 2 or more channels; and n is number of identical layer multiplications that are employed.

For multilayer structures of two component materials A and B, a three layer ABA initial structure is frequently employed to result in a final film or sheet where the outside layers are the same on both sides of the film or sheet after the layer multiplication step(s). Where the A and B layers in the final film or sheet are intended to be generally equal thickness and equal volume percentages, the two A layers in the starting ABA layer structure are half the thickness of the B layer but, when combined together in layer multiplication, provide the same layer thickness (excepting the two, thinner outside layers) and comprise half of the volume percentage-wise. As can be seen, since the layer multiplication process divides and stacks the starting structure multiple times, two outside A layers are always combined each time the feedstream is “stacked” and then add up to equal the B layer thickness. In general, the starting A and B layer thicknesses (relative volume percentages) are used to provide the desired relative thicknesses of the A and B layers in the final film. Since the combination of two adjacent, like layers appears to produce only a single discrete layer for layer counting purposes, the general formula Nₜ=(2)⁽ⁿ⁺¹⁾+1 is used for calculating the total numbers of “discrete” layers in a multilayer structure using an “ABA” feedblock and repeated, identical layer multipliers where Nₜ is the total number of layers in the final structure; 3 initial layers are produced by the feedblock; a layer multiplication is division into and stacking of 2 channels; and n is number of identical layer multiplications that are employed.

A suitable two component coextrusion system (e.g., repetitions of “AB” or “ABA”) has two ¾ inch (19.25 mm) single screw extruders connected by a melt pump to a coextrusion feedblock. The melt pumps control the two melt streams that are combined in the feedblock as two or three parallel layers in a multilayer feedstream. Adjusting the melt pump speed varies the relative layer volumes (thicknesses) and thus the thickness ratio of layer A to layer B. From the feedblock, the feedstream melt goes through a series of multiplying elements. It is understood that the number of extruders used to pump melt streams to the feedblock in the fabrication of the structures of the disclosure generally equals the number of different components. Thus, a three-component repeating segment in the multilayer structure (ABC . . . ), requires three extruders.

Examples of known feedblock processes and technology are illustrated in WO 2008/008875; U.S. Pat. No. 3,565,985; U.S. Pat. No. 3,557,265; and U.S. Pat. No. 3,884,606, each of which is hereby incorporated by reference herein. Layer multiplication process steps are shown, for example, in U.S. Pat. Nos. 5,094,788 and 5,094,793, hereby incorporated herein by reference, teaching the formation of a multilayer flow stream by dividing a multilayer flow stream containing the thermoplastic resinous materials into first, second and optionally other substreams and combining the multiple substreams in a stacking fashion and compressing, thereby forming a multilayer flow stream. As may be needed depending upon materials being employed for film or sheet production and the film or sheet structures desired, films or sheet comprising two or more layers of the multilayer flow stream can be provided by encapsulation techniques such as shown by U.S. Pat. No. 4,842,791 encapsulating with one or more generally circular or rectangular encapsulating layers stacked around a core; as shown by of U.S. Pat. No. 6,685,872 with a generally circular, nonuniform encapsulating layer; and/or as shown by WO 2010/096608A2 where encapsulated multilayered films or sheet are produced in an annular die process. U.S. Pat. Nos. 4,842,791 and 6,685,872 and WO 2010/096608A2 are hereby incorporated by reference herein.

In an embodiment, the core component has a total thickness from 0.1 mil (2.54 micrometers) to 10.0 mil (254 micrometers). In a further embodiment, the core component has a thickness from 0.1 mil, or 0.2 mil, or 0.3 mil, or 0.4 mil, or 0.5 mil, to 0.8 mil, or 1.0 mil, or 1.5 mil, or 2.0 mil, or 3.0 mil, or 5.0 mil, or 7.7 mil, or 10.0 mil.

In an embodiment, the core component of the multilayer film includes layer A having a thickness from 100 nm to 400 nm; and layer B having a thickness from 100 nm to 400.

In an embodiment, layer A includes a high density polyethylene (HDPE) having a density of at least 0.94 g/cc.

In an embodiment, the layer A has a thickness from 100 nm to 400 nm and includes a high density polyethylene having a density from 0.95 g/cc to 0.97 g/cc. Layer B includes a cyclic block copolymer. In a further embodiment, the cyclic block copolymer is a pentablock hydrogenated styrene.

In an embodiment, the multilayer film includes layer A with a thickness from 100 nm to 400 nm and includes a high density polyethylene having a density from 0.95 g/cc to 0.97 g/cc and a melt index from 0.1 g/10 min. to 1.0 g/10 min. Layer B has a thickness from 100 nm to 400 nm and includes a cyclic block copolymer. Layer A has an effective moisture permeability from 0.03 to less than 0.1 g-mil/100 in²/day (from 0.46 to less than 1.55 g-mil/m²/24 hr) and an effective oxygen permeability from 20 to less than 60 cc-mil/100 in²/day/atm (from 310 to less than 930 cc-mil/m²/24 hr/atm). In a further embodiment, the HDPE of layer A includes a truncated spherulite structure.

In an embodiment, the multilayer film includes the core component with from 60 to 70, or 65, alternating layers of layer A and layer B. The core component includes layer A with a thickness from 100 nm to 400 nm. Layer A is composed of a high density polyethylene having a density from 0.95 g/cc to 0.97 g/cc. Layer B has a thickness from 100 nm to 400 nm and includes a cyclic block copolymer. Layer A has an effective moisture permeability from 0.03, or 0.04, or 0.05, or 0.06 to 0.07, or 0.08, or 0.09 to less than 0.1 g-mil/100 in²/day (from 0.46, or 0.62, or 0.78, or 0.93 to 1.08, or 1.24, or 1.40 to less than 1.55 g-mil/m²/24 hr) and an effective oxygen permeability from 20, or 30, or 40 to 50, or 55, or less than 60 cc-mil/100 in²/day/atm (from 310, or 465, or 620 to 775, or 852.5, or less than 930 cc-mil/m²/24 hr/atm).

The core component may comprise two or more embodiments disclosed herein.

4. Skin Layers

In an embodiment, the multilayer film includes at least one skin layer. In a further embodiment, the multilayer film includes two skin layers. The skin layers are outermost layers, with a skin layer on each side of the core component. The skin layers oppose each other and sandwich the core component. The composition of each individual skin layer may be the same or different as the other skin layer. Nonlimiting examples of suitable polymers that can be used as skin layers include polypropylenes, polyethylene oxide, polycaprolactone, polyamides, polyesters, polyvinylidene fluoride, polystyrene, polycarbonate, polymethylmethacrylate, polyamides, ethylene-co-acrylic acid copolymers, polyoxymethylene and blends of two or more of these; and blends with other polymers comprising one or more of these.

In an embodiment, the skin layers include propylene-based polymer, ethylene-based polymer polyethylene, polyethylene copolymers, polypropylene, propylene copolymer, polyamide, polystyrene, polycarbonate and polyethylene-co-acrylic acid copolymers.

The thickness of each skin layer may be the same or different. The two skin layers have a thickness from 5%, or 10%, or 15% to 20%, or 30%, or 35% the total volume of multilayer film.

In an embodiment, the thickness of the skin layers is the same. The two skin layers with the same thickness are present in multilayer film in the volume percent set forth above. For example, a multilayer film with 35% skin layer indicates each skin layer is present at 17.5% the total volume of the multilayer film.

In an embodiment, the composition of each skin layer is the same and is polyethylene. The polyethylene can be a low density polyethylene or an HDPE. In a further embodiment, each skin layer includes a HDPE with a density from 0.95 glee to 0.97 g/cc. The skin layers are present from 20% to 35% the total volume of the multilayer film.

5. Optional Other Layer

The skin layers may be in direct contact with the core component (no intervening layers). Alternatively, the multilayer film may include one or more intervening layers between each skin layer and the core component. The present multilayer film may include optional additional layers. The optional layer(s) may be intervening layers (or internal layers) located between the core component and the skin layer(s). Such intervening layers (or internal layers) may be single, repeating, or regularly repeating layer(s). Such optional layers can include the materials that have (or provide) sufficient adhesion and provide desired properties to the films or sheet, such as tie layers, barrier layers, skin layers, etc.

Nonlimiting examples of suitable polymers that can be employed as tie or adhesive layers include: olefin block copolymers such as propylene-based block copolymer sold under the tradename INTUNE™ (The Dow Chemical Company) and ethylene-based block copolymer sold under the tradename INFUSE™ (The Dow Chemical Company); polar ethylene copolymers such as copolymers with vinyl acetate, acrylic acid, methyl acrylate, and ethyl acrylate; ionomers; maleic anhydride-grafted ethylene polymers and copolymers; blends of two or more of these; and blends with other polymers comprising one or more of these.

Nonlimiting examples of suitable polymers that can be employed as barrier layers include: polyethylene terephthalate, ethylene vinyl alcohol, polyvinylidene chloride copolymers, polyamides, polyketones, MXD6 nylon, blends of two or more of these; and blends with other polymers comprising one or more of these.

As noted above, the multilayer film according to the present disclosure can be advantageously employed as a component in thicker structures having other inner layers that provide structure or other properties in the final article. For example, the skin layers can be selected to have an additional desirable properties such as toughness, printability and the like are advantageously employed on either side of the core component to provide films suitable for packaging and many other applications where their combinations of moisture barrier, gas barrier, physical properties and low cost will be well suited. In another aspect of the present disclosure, tie layers can be used with the multi layer film or sheet structures according to the present disclosure.

6. Multilayer Film

The present multilayer film can be a stand-alone film or can be a component of another film, a laminate, a sheet, or an article.

The present multilayer film may be used as films or sheets for various known film or sheet applications or as layers in thicker structures and to maintain light weight and low costs.

When employed in this way in a laminate structure or article with outer surface or skin layers and optional other inner layers, the present multilayer film can be used to provide at least 5 volume % of a desirable film or sheet, including in the form of a profile, tube, parison or other laminate article, the balance of which is made up by up to 95 volume % of additional outer surface or skin layers and/or inner layers.

In an embodiment, the present multilayer film provides at least 10 volume %, or at least 15 volume %, or at least 20 volume %, or at least 25 volume %, or at least 30 volume % of a laminate article.

In an embodiment, the present multilayer film provides up to 100 volume %, or less than 80 volume %, or less than 70 volume %, or less than 60 volume %, or less than 50 volume %.

In an embodiment, the multilayer film includes the core component and skin layers. The core component can be any core component as disclosed above. The multilayer film has an oxygen permeability less than 105 cc-mil/100 in²/day/atm (less than 1627.5 cc-mil/m²/24 hr/atm) and a moisture permeability less than 0.2 g-mil/100 in²/day (less than 3.1 g-mil/m²/24 hr). In a further embodiment, each skin layer is a polyethylene. In yet a further embodiment, each skin layer is a HDPE having a density from 0.95 g/cc to 097 glee.

In an embodiment, the multilayer film includes the core component and skin layers. Each skin layer is a HDPE having a density from 0.95 g/cc to 0.97 glee. Layer A has a thickness from 100 nm to 400 nm and includes a HDPE having a density from 0.95 g/cc to 0.97 glee. Layer B has a thickness from 100 nm to 400 nm and includes a cyclic block copolymer. The multilayer film has an oxygen permeability from 60, or 65, or 68, or 70, or 75, or 80, to 85, or 90, or 95, or 100, or less than 105 cc-mil/100 in²/day/atm (from 930, or 1007.5, or 1054, or 1085, or 1162.5, or 1240 to 1317.5, or 1395, or 1472.5, or 1550, or less than 1627.5 cc-mil/m²/24 hr/atm). The multilayer film also has a moisture permeability from 0.05, or 0.08, or 0.09, or 0.1, to 0.13, or 0.15, or less than 0.2 g-mil/100 in²/day (from 0.78, or 1.24, or 1.40, or 1.55 to 2.02, or 2.32, or less than 3.1 g-mil/m²/24 hr). In a further embodiment, the core component is from 75% to 65% of the total multilayer film volume and the skin layers are from 25% to 35% of the total multilayer film volume.

In an embodiment, the multilayer film has an overall thickness from 0.1 mil (2.54 micrometers), or 0.2 mil, or 0.5 mil, or 1.0 mil, or 1.5 mil, or 2.0 mil, or 2.5 mil, or 3.0 mil to 5.0 mil, or 10.0 mil (254 micrometers).

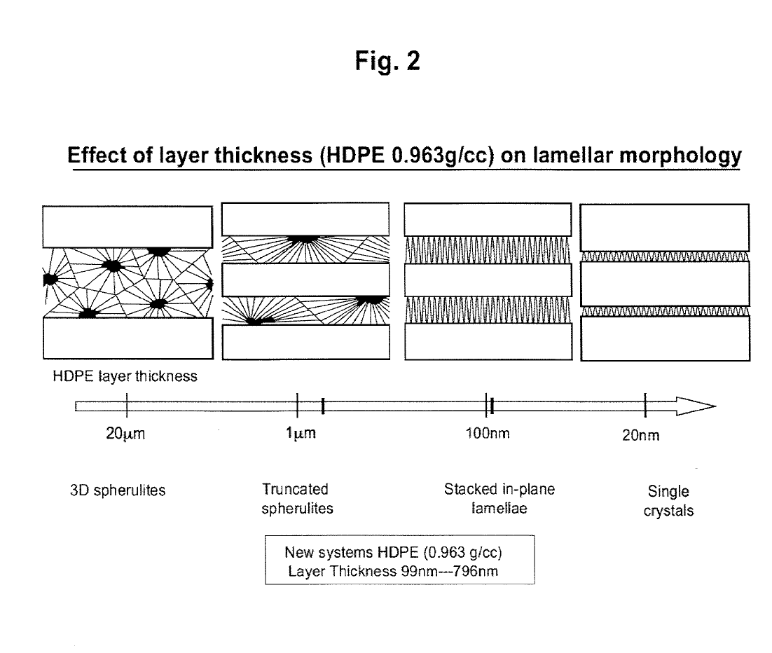

For nanolayer structures, two relationships exist which influence barrier property—(i) crystal lamella orientation and (ii) % crystallinity. It is known that the thinner the nanolayer becomes, the morphology moves from spherulitic with an overall random orientation of lamellae but containing some of which are in the edge-on orientation, to in-plane lamellae as shown in the schematic representation in FIG. 2. However, orientation is inversely related to crystallinity, such that as confinement increases (barrier becomes thinner), the degree of crystallinity for the barrier polymer decreases, reducing barrier capability. Moreover, many barrier resins do not form “in-plane” lamellae crystals upon confinement and only drop % crystallinity, and thus deteriorate the barrier property. Therefore, for many barrier materials, it is necessary to maintain overall % crystallinity as high as possible and reduce the portions of “edge-on” lamellae in the spherulitic crystals.

Bounded by no particular theory, Applicant discovered that creation of truncated spherulites in nanolayer structures unexpectedly optimizes barrier capability. With (1) control of layer thickness and (2) selection of barrier and constraining components, nanolayer with truncated spherulite morphology can be obtained which exhibit unexpected improvement in moisture permeability.

A “spherulite” is a superstructure observed in many semi-crystalline polymers and is composed of branched crystal lamella radiating from a central nucleation point. If spherulite growth is not confined, the spherulite grows in the radial direction symmetrically as a sphere until it impinges on other spherulites. The lamella direction in the spherulite is, on average, random. A “truncated spherulite” is a spherulite that is confined in at least one dimension by the thickness of the film from which it is grown. If the film is grown in the horizontal plane, growth is terminated at the top and the bottom (perpendicular to horizontal plane) while growth more parallel to the film continues as in the unconfined example, until another spherulite (also truncated by the constraining layer) is encountered. The truncated spherulite is not symmetric and the lamella orientation is, on average, no longer random. A truncated spherulite is formed by eliminating a top portion and a bottom portion of the spherulite with opposing constraining layers. A truncated spherulite has lamella with a more perpendicular component to its direction, relative to the horizontal plane of the film.

Bounded by no particular theory, Applicant discovered that creation of truncated spherulites in nanolayer structures unexpectedly optimizes barrier capability. With (1) control of layer thickness and (2) selection of barrier and constraining components, nanolayer with truncated spherulite orientation can be obtained which exhibit unexpected improvement in both effective moisture permeability and effective oxygen permeability.

As a benchmark, polyethylene oxide (PEO) barrier shows a relationship of starting at a low permeation rate with the thinnest layers due to in-plane crystal lamella, and then rising to the permeation rate of bulk polymer as layer thickness increases.

In contrast, for polyethylene it is known that at small layer thickness in nanolayer film, edge-on crystal lamella are present which do not yield a decrease in permeation rate over that of the bulk. See for example Pan et al, J. Polym. Sci., Polym. Phys., 28 1105 (1990).

Applicant unexpectedly discovered and created a nanolayer configuration whereby that polyethylene (and HDPE in particular) exhibits an optimal permeation rate with layer thickness from 100 nm to 500 nm.

The HDPE (barrier polymer layer A) creates “edge-on” lamellae structure due to an active surface (interface) nucleation when the HDPE is constrained by COP (layer B). Applicant discovered, that at optimal layer thickness (100 nm to 500 nm), the edge-on portions of the lamellae structure are removed (or truncated) from the spherulites, leaving the remaining portion of the spherulitic structure without a reduction in crystallinity. Applicant's truncated spherulitic structure increases the ratio of “in-plane” lamellae (good for barrier) to “edge-on” lamellae (poor for barrier) compared to random oriented lamellae structure (snowflake) in an unconstrained system. This truncated spherulitic structure unexpectedly finds a balance between orientation and crystallinity and exhibits a synergistic improvement in both effective moisture permeability and effective oxygen permeability.

7. Article

The present disclosure provides an article. In an embodiment, the present multilayer film is a component of an article. Nonlimiting examples of suitable articles include laminate structures, die formed articles, thermoformed articles, vacuum formed articles, or pressure formed articles. Other articles include tubes, parisons, and blow molded articles such as bottles or other containers.

### Test Methods

Density is measured in accordance with ASTM D 792.

Effective permeability (Pelf). The effective permeability (moisture and oxygen) for an individual barrier layer is calculated using Equation (1) as follows:

$${P}_{B} = {{V}_{B} ( \frac{1}{P} - \frac{1 - {V}_{B}}{{P}_{c}} )}^{- 1} \qquad Equation 1$$

wherein P is the permeability of the nanolayer component, V_{B} and V_{C} are the volume fraction of the barrier and confining polymers, respectively, and P_{B} and P_{C} are the permeability of the barrier and confining polymers, respectively. Effective moisture permeability is measured as g-mil/100 inch² (in²)/day and g-mil/meter² (m²)/24 hour (hr). Effective oxygen permeability is measured as cc-mil/100 inch² (in²)/day/atm and cc-mil/meter² (m²)/24 hour (hr)/atm.

Melt flow rate (MFR) is measured 1 accordance with ASTM D 1238, Condition 280° C./2.16 kg (g/10 minutes).

Melt index (MI) is measured in accordance with ASTM D 1238, Condition 190° C./2.16 kg (g/10 minutes).

Moisture permeability is a normalized calculation performed by first measuring Water Vapor Transmission Rate (WVTR) for a given film thickness. WVTR is measured at 38° C., 100% relative humidity and 1 atm pressure are measured with a MOCON Permatran-W 3/31. The instrument is calibrated with National Institute of Standards and Technology certified 25 μm-thick polyester film of known water vapor transport characteristics. The specimens are prepared and the WVTR is performed according to ASTM F1249.

Oxygen permeability is a normalized calculation performed by first measuring Oxygen Transmission Rate (OTR) for a given film thickness. OTR is measured at 23° C., 0% relative humidity and 1 atm pressure are measured with a MOCON OX-TRAN 2/20. The instrument is calibrated with National Institute of Standards and Technology certified Mylar film of known O₂ transport characteristics. The specimens are prepared and the OTR is performed according to ASTM D 3985.

Some embodiments of the present disclosure will now be described in detail in the following Examples.

### Examples

In the present examples, experimental films according to the present disclosure (unless noted to be “controls”) are prepared from ethylene-based polymer layers (i.e., high density polyethylene (“HDPE”)) coextruded with cyclic olefin polymer layers.

Table 1 summarizes the COP materials giving trade name, density, cyclic unit, weight percentage of the cyclic units, control film. The COP material HP030 is commercially available from Taiwan Rubber Company.

TABLE 1
COP

| | | | MFR | | | Oxygen | Moisture |
|---|---|---|---|---|---|---|---|
| | | | (g/10 min) | | Wt % | permeability | permeabiltiy |
| | Trade | Density | @ | Cyclic Olefin | Cyclic Olefin | (cc-mil/ | (g-mil/ |
| COP | Name | (g/cc) | 280° C./2.16 kg | Unit | Unit | 100 in²/day/atm) | 100 in²/day) |
| Cyclic | HP030 | 0.941 | 39 | Pentablock | >40% | 372 | 1.1 |
| Block | | | | Hydrogenated | | (5766**) | (17.05*) |
| Copolymer | | | | Styrene | | | |
| 1 (CBC1) | | | | | | | |

*g-mil/m²/24 h
**cc-mil/m²/24 hr/atm

Table 2 summarizes the ethylene-based polymer material designation, Trade name, and control film Oxygen Transmission Rate (OTR) values and control film Water Vapor Transmission Rate (WVTR) values.

TABLE 2
Ethylene Polymers

| | | MFR (g/ | | Oxygen | Moisture |
|---|---|---|---|---|---|
| | | 10 min) @ | | permeability | permeability |
| | Trade | 190° C./ | Density | (cc-mil/ | (g-mil/ |
| | Name | 2.16 kg | (g/cc) | 100 in²/day/atm) | 100 in²/day) |
| HDPE1 | NA | 0 | 0.96 | 83.5 | 0.20 |
| | | | | (1294.2**) | (3.1*) |

*g-mil/m²/24 hr
**cc-mil/m²/24 hr/atm

HDPE1 is produced by The Dow Chemical Company.

Experimental films are prepared having 33, 65, 129 and 257 thin layers of alternating HDPE and cyclic olefin polymer (COP) where the resulting final layer thicknesses provided by the final thicknesses to which the films are drawn down to. The nominal film thickness (“Nom. Film Thickness”), nominal COP layer thickness, nominal HDPE1 thickness and total skin layer volume percentage (includes both skin layers) are given in Table 3 below. The present multilayer film is made by a feedblock process as previously described and shown in FIG. 1.

The core component is made with A polymer (HDPE1) and B polymer (CBC1), and is extruded by two ¾ inch (19.05 mm) single screw extruders connected by a melt pump to a coextrusion feedblock with an BAB feedblock configuration (as described above). The melt pumps control the two melt streams that are combined in the feedblock; by adjusting the melt pump speed, the relative layer thickness, that is, the ratio of A to B can be varied. The feedblock provides a feedstream to the layer multipliers as 3 parallel layers in a BAB configuration with B split into equal thicknesses of B layer on either side of A layer in the total A:B volume ratios shown in the tables. Then, seven layer multiplications are employed, each dividing the stream into 2 channels and stacking them to provide a final film having 33, 65, 129, or 257 alternating discrete microlayers. Skin layers of HDPE1 that are about 34 or 50 volume percent of the final film are provided to each surface (17 or 25 vol % to each side of the film) by an additional extruder.

The extruders, multipliers and die temperatures are set to 240° C. for all the streams and layers of the multilayer products to ensure matching viscosities of the two polymer melts. The multilayer extrudate is extruded from a flat 14 inch (35.5 cm) die having a die gap of 20 mils to a chill roll having a temperature of 80° C. with almost no air gap between the die and chill roll and providing a relatively fast cooling of the film. The overall flow rate is about 3 lbs/hr (1.36 kg/hr).

Embedded films are microtomed through the thickness at −75° C. with a cryo-ultramicrotome (MT6000-XL from RMC) and cross-sections are examined with an atomic force microscope (TEM) to visualize the layers and the morphology inside layers. Phase and height images or the cross-section are recorded simultaneously at ambient temperature in air using the tapping mode of the Nanoscope IIIa MultiMode scanning probe (Digital Instruments. Although there is some non-uniformity, the average layer thickness is observed to be quite close to the nominal layer thickness calculated from the film thickness, the composition ratio and the total number of layers.

A control film is extruded from HDPE1, resin and tested as described below for control effective moisture permeability values and control for effective oxygen permeability.

TABLE 3
Peff, Oxygen Permeability, Moisture Permeability for HDPE1 nanolayer barrier with truncated spherulites

| | Oxygen | Moisture | | | | |
|---|---|---|---|---|---|---|
| | Barrier | Barrier | | | | |
| | Peff, | Peff, | | | | |
| | HDPE1 | HDPE1 | | | | |
| HDPE1 control | 83.5 | 0.2 | | | | |
| (1.0 mil) | (1294.2**) | (3.1*) | | | | |
| Nominal HDPE1 | | | | overall | | |
| layer thickness | | | | composition | Oxygen | Moisture |
| (nm) | | | Sample info | (HDPE1/CBC1) | permeability | permeability |
| 99 | 75.4 | 0.11 | 257 layer, | 83/17 | 90.2 | 0.16 |
| | (1168.7**) | (1.70*) | HDPE1[HDPE1/CBC1]HDPE1 = | | (1398.1**) | (2.48*) |
| | | | 17[49.5/16.5]17 | | | |
| 198 | 64.3 | 0.09 | 129 layer, | 83/17 | 81.8 | 0.14 |
| | (996.6**) | (1.40*) | HDPE1[HDPE1/CBC1]HDPE1 = | | (1269.9**) | (2.17*) |
| | | | 17[49.5/16.5]17 | | | |
| 261 | 47.1 | 0.06 | 65 layer, | 67/33 | 83.5 | 0.13 |
| | (730.0**) | (0.93*) | HDPE1[HDPE1/CBC1]HDPE1 = | | (1294.2**) | (2.02*) |
| | | | 17[33/33]17 | | | |
| 290 | 45.3 | 0.04 | 65 layer, | 87.5/12.5 | 68.5 | 0.08 |
| | (702.2**) | (0.62*) | HDPE1[HDPE1/CBC1]HDPE1 = | | (1061.8**) | (1.24*) |
| | | | 25[37.5/12.5]25 | | | |
| 350 | 55.3 | 0.05 | 65 layer, | 95/5 | 70.1 | 0.09 |
| | (857.2**) | (0.78*) | HDPE1[HDPE1/CBC1]HDPE1 = | | (1086.6**) | (1.40*) |
| | | | 25[45/5]25 | | | |
| 396 | 56.4 | 0.07 | 65 layer, | 83/17 | 75.2 | 0.11 |
| | (874.2**) | (1.08*) | HDPE1[HDPE1/CBC1]HDPE1 = | | (1165.6**) | (1.70*) |
| | | | 17[49.5/16.5]17 | | | |
| 440 | 89.2 | 0.09 | 65 layer, | 91/19 | 101.9 | 0.13 |
| | (104.7**) | (1.40*) | HDPE1[HDPE1/CBC1]HDPE1 = | | (1579.4**) | (2.02*) |
| | | | 12.5[56.3/18.7]12.5 | | | |
| 470 | 92.2 | 0.09 | 65 layer, | 93/7 | 93.5 | 0.12 |
| | (1429.1**) | (1.40*) | HDPE1[HDPE1/CBC1]HDPE1 = | | (1449.2**) | (1.86*) |
| | | | 17[59.4/6.6]17 | | | |
| 792 | 96.3 | 0.12 | 33 layer, | 83/17 | 103.5 | 0.17 |
| | (1492.6**) | (1.86*) | HDPE1[HDPE1/CBC1]HDPE1 = | | (1604.2**) | (2.64*) |
| | | | 17[49.5/16.5]17 | | | |

Peff--Oxygen barrier --Peff, HDPE1 (cc-mil/100 in²/day/atm)
Peff--Moisture barrier--Peff, HDPE1 (g-mil/100 in²/day)
Oxygen permeability--(cc-mil/100 in²/day/atm)
Moisture permeability--(g-mil/100 in²/day)
*g-mil/m²/24 hr
**cc-mil/m²/24 hr/atm

Peff calculation for moisture permeability (g-mil/100 in²/day) and oxygen permeability (cc-mil/100 in²/day/atm):

$$Peff , barrier polymer = {P}_{B} = {{V}_{B} ( \frac{1}{P} - \frac{1 - {V}_{B}}{{P}_{c}} )}^{- 1}$$

This equation can be extended to 3 material system (barrier polymer, confining polymer, and skin material as:

$${P}_{eff , HDPE} = {{V}_{HDPE} ( \frac{1}{P} - \frac{{V}_{c}}{{P}_{c}} - \frac{{V}_{skin}}{{P}_{skin}} )}^{- 1}$$

Moisture permeability and oxygen permeability calculation. This shows how the permeability should be in the given composition. If measured moisture permeability or the oxygen permeability is below the calculated value, then it is a proof of improvement in barrier:

$$P = {( \frac{{∅}_{A}}{{P}_{A}} + \frac{1 - {∅}_{A}}{{P}_{B}} )}^{- 1}$$

This equation can be extended to a three-material system as well:

$$P = {( \frac{{∅}_{B}}{{P}_{B}} + \frac{{∅}_{C}}{{P}_{C}} + \frac{{∅}_{skin}}{{P}_{skin}} )}^{- 1}$$

Calculations for Example in Table 3 with 290 nm thick HDPE1 barrier layer and CBC1 constraining layer.
(1) Calculation for Peff13 moisture: Peff, HDPE1=0.375(1/0.08−0.125/1.1−0.5/0.2)̂−1=0.04 (input values: volume of HDPE1 in the microlayer core=0.375 (37.5%), overall film moisture permeability=0.08, volume of CBC1=0.125, CBC1 permeability=1.1, volume of HDPE1 skin=0.5, and skin HDPE1 permeability=0.2)
(2) Calculation for Peff—oxygen: Peff, HDPE1=0.375(1/68.47-0.125/367.4-0.5/83.5)̂-1=45.31 (input values: volume of HDPE1=0.375 (37.5%), film oxygen permeability=68.47, volume of CBC1=0.125, CBC1 permeability=367.4, volume of skin=0.5, and skin permeability=83.5)
(3) Measured moisture permeability=0.08, the calculated moisture permeability: P—(0.375/0.2+0.125/1.1+0.5/0.2)̂-1=0.22->means improvement by microlayering
(4) Measured oxygen permeability=66.9, the calculated oxygen permeability: P=(0.375/83.5+0.125/367+0.5/83.5)̂−1=92.4->means improvement by microlayering.

The series model can be expanded as shown below to accommodate as many components as needed:

$$\frac{1}{P} = \frac{{∅}_{1}}{{P}_{1}} + \frac{{∅}_{2}}{{P}_{2}} + \frac{{∅}_{3}}{{P}_{3}} … …$$

Where P=the measured permeability of the multilayer film.
   φᵢ=the volume fraction of the polymer i
   Pᵢ=permeability of polymer i

Applicant discovered that 100 nm to 500 nm HDPE1 barrier with truncated spherulitic structure exhibits an unexpected drop (i.e., improved barrier properties) in both effective moisture permeability and in effective oxygen permeability.

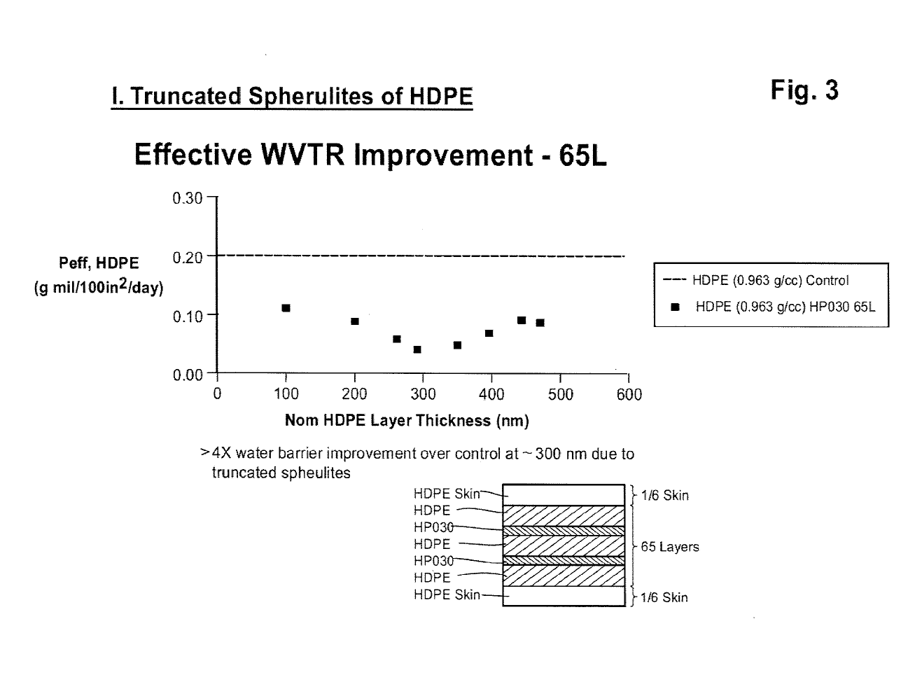

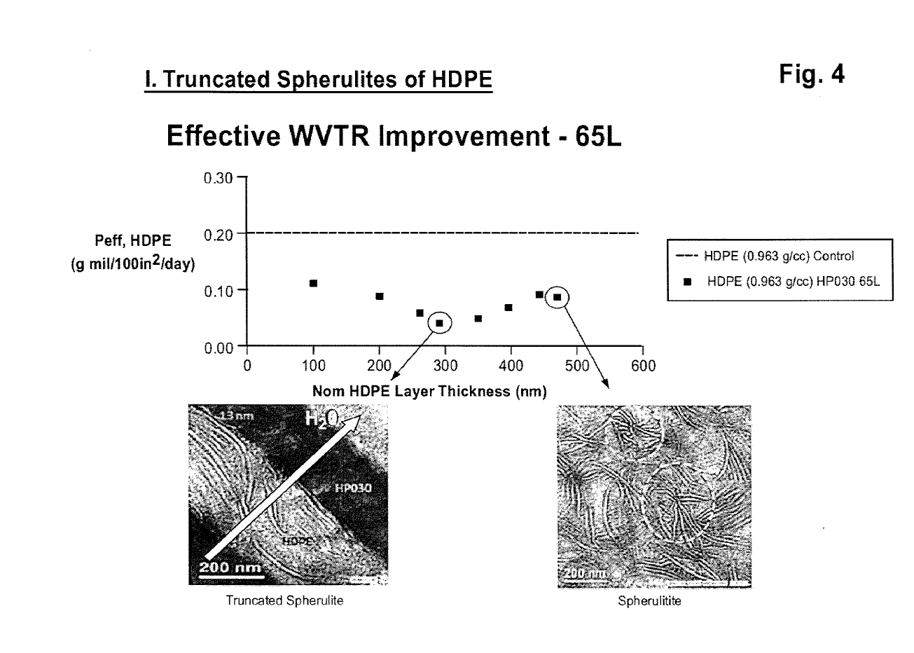

The effective moisture permeability for 65 layer core component is shown in FIGS. 3-4. FIG. 3 shows the effective moisture permeability decrease to less than or equal to 0.1 g-mil/100 in²/day (less than or equal to 1.55 g-mil/m²/24 hr). The HDPE1 layer thickness moves from 100 nm to 500 nm.

FIG. 4 shows two transmission electron microscopy (TEM) phase images. The first TEM phase image is a partial cross section of the 65 layer core component with 290 nm thick HDPE1 barrier. The first TEM phase image shows the presence of truncated spherulites. The second TEM phase image is a partial cross section of the 65 layer core component with 470 nm thick HDPE1 barrier. The second TEM image shows spherulitic structure and truncated spherulitic structure. X-ray scattering shows the presence of edge-on lamellae at HDPE1 layer thickness from 99 nm to 198 nm. This confirms that the effective moisture permeability is due to the presence of truncated spherulites in HDPE1 layer from 100 nm to 500 nm.

It is specifically intended that the present disclosure not be limited to the embodiments and illustrations contained herein, but include modified forms of those embodiments including portions of the embodiments and combinations of elements of different embodiments as come within the scope of the following claims.

1. A coextruded multilayer film comprising:
a core component comprising from 15 to 1000 alternating layers of layer A and layer B;
layer A having a thickness from 100 nm to 500 nm and comprising an ethylene-based polymer;
layer B having a thickness from 100 nm to 500 nm and comprising a cyclic olefin polymer (“COP”); and
layer A has an effective moisture permeability less than 0.20 g-mil/100 in²/day and an effective oxygen permeability less than 150 cc-mil/100 in²/day/atm.

2. The multilayer film of claim 1 wherein layer A has a thickness from 100 nm to 400 nm; and
Layer B has a thickness from 100 nm to 400.

3. The multilayer film of claim 1 wherein layer A comprises a high density polyethylene (HDPE) having a density of at least 0.94 g/cc.

4. The multilayer film of claim 1 wherein the layer A has a thickness from 100 nm to 400 nm and comprises a high density polyethylene having a density from 0.95 g/cc to 0.97 g/cc.

5. The multilayer film of claim 4 wherein the B layer comprises a cyclic block copolymer.

6. The multilayer film of claim 5 wherein the cyclic block copolymer comprises a pentablock hydrogenated styrene.

7. The multilayer film of claim 1 wherein layer A has a thickness from 100 nm to 400 nm and comprises a high density polyethylene having a density from 0.95 g/cc to 0.97 g/cc;
layer B has a thickness from 100 nm to 400 nm and comprises a cyclic block copolymer; and
layer A has an effective moisture permeability from 0.03 to less than 0.1 g-mil/100 in²/day and an effective oxygen permeability from 20 to less than 60 cc-mil/100 in²/day/atm.

8. The multilayer film of claim 1 wherein the core component comprises from 60 to 70 alternating layers of layer A and layer B.

9. The multilayer film of claim 1 wherein layer A comprises HDPE having a density for 0.95 g/cc to 0.97 g/cc and the HDPE comprises a truncated spherulite structure.

10. The multilayer film of claim 1 wherein the core component has a thickness from 0.1 mil to 10.0 mil.

11. A multilayer film of claim 1 comprising skin layers.

12. The multilayer film of claim 11 wherein the multilayer film has an oxygen permeability less than 105 cc-mil/100 in²/day/atm and a moisture permeability less than 0.20 g-mil/100 in²/day.

13. The multilayer film of claim 11 wherein at least one skin layer comprises a polyethylene.

14. The multilayer film of claim 11 wherein each skin layer comprises a high density polyethylene having a density from 0.95 g/cc to 0.97 g/cc.

15. The multilayer film of claim 11 wherein layer A has a thickness from 100 nm to 400 nm and comprises a high density polyethylene having a density from 0.95 g/cc to 0.97 g/cc;
layer B has a thickness from 100 nm to 400 nm and comprises a cyclic block copolymer; and
the multilayer film has an oxygen permeability from 70 to less than 100 c-mil/100 in²/day/atm and a moisture permeability from 0.05 to less than 0.15 g-mil/100 in²/day.

16. The multilayer film of claim 11 wherein the core component comprises from 75% to 65% of total multilayer film volume and the skin layer comprises from 25% to 35% of the total multilayer film volume.

17. The multilayer film of claim 11 wherein the core component has a thickness of from 0.1 mil to 10 mils.

18. An article comprising the multilayer film of claim 1.
